(19) United States
(12) Patent Application Publication
(10) Pub. No.: US 2015/0067998 A1
(43) Pub. Date: Mar. 12, 2015

(54) METHOD AND APPARATUS FOR TREATING HUMAN REMAINS BY CHILLING

(71) Applicant: ECOLEGACY LIMITED, Dublin 2 (IE)

(72) Inventors: Damian Tinsley, Craigavad (GB); Joe Ennis, Dublin 16 (IE); Stephen Lusty, Donaghadee (GB)

(73) Assignee: ECOLEGACY LIMITED, Dublin 2 (IE)

(21) Appl. No.: 14/398,918

(22) PCT Filed: May 7, 2013
(86) PCT No.: PCT/IE2013/000013

§ 371 Date: Nov. 4, 2014

Related U.S. Application Data
(60) Provisional application No. 61/642,549, filed on May 4, 2012.
(60) Provisional application No. 61/642,550, filed on May 4, 2012.

(51) Int. Cl. F26B 5/06; F26B 21/02; B02C 19/18

(52) U.S. Cl. CPC F26B 5/06; B02C 19/18; F26B 21/02
USPC 27/21.1

(57) ABSTRACT

A method of treating human remains prior to burial or other means of disposal comprises the steps of freezing the remains and size reducing the remains to particulate matter. The freezing step includes the steps of placing the remains in a freezing chamber, charging the chamber with a gas, and circulating the gas in a loop between the freezing chamber and a cooling device. The gas cooling device is adapted to cool the gas to a temperature below −100° C. while maintaining the gas in a gaseous form. The gas cooling device may include a heatsink and a means for cooling the heatsink, wherein the circulating gas is cooled by being brought into contact with the heatsink.

### TECHNICAL FIELD

The invention relates to a method and apparatus for treating human remains. In particular, the invention relates to a method and apparatus for freezing a deceased human body.

### BACKGROUND ART

Traditionally, human remains are stored after death for a period of time prior to commitment. In most cases, the remains are initially embalmed, which involves draining the blood from the body and replacing it with an embalming fluid such as formalin, which serves to delay the decaying process. The remains are then generally either buried in a cask in the ground, or cremated.

There are a number of problems associated with these established practices. The problems associated with burial include ecological problems, namely that the toxins in the body eventually make their way into the ground and water table. These toxins include formalin, which is toxic and has recently been recognised as a carcinogen, mercury (which is present in dental fillings), and numerous other carcinogens. In addition, the body may also contain microbiological pathogens, including bacteria such as E. coli and S. aureus, viral pathogens and prions. A further problem associated with burial is that the conditions prevent mouldering of the body, with the result that the body rots under the influence of sulphur-producing bacteria, taking 80 years or more to fully decompose. Cremation is perceived as a cleaner, and more ecologically friendly, commitment process, and involves burning the remains at a high temperature of approximately 900° C. for a period of one to a few hours, depending on the size of the body. Any remaining skeletal bones may be crushed to provide the final ash, which is placed in an urn for final disposition. This is an energy intensive process, producing flue gases which are released into the atmosphere. These flue gases are known to include many toxins, including mercury.

Various attempts have been made to provide more ecologically, and environmentally, friendly methods of treating and disposing of human remains. For example, the literature includes details of numerous alternative processes, where the human remains are chilled, generally in liquid nitrogen, then fractured into particulate matter, and then freeze-dried to remove water, before finally being buried in shallow ground to allow aerobic decomposition take place. Examples of this prior art include the following documents:

U.S. Pat. No. 4,067,091 (Backman—1976)—describes a process of treating human remains which involves cryogenically cooling the remains in liquid nitrogen, size reducing the remains using mechanical means, freeze-drying the particulate matter to remove about 95% of water, and depositing the freeze-dried material in a storage container.

International (PCT) Application No: WO01/03516 (Max World Technology Inc—1999)—describes a process for treatment of biological waste similar to that of Backman (above) except that prior to cryogenically cooling the biological waste is subject to a dehydration step where at least 80% of water is removed. The process of the invention is intended for use with food, animal waste etc; use with human remains is not suggested.

European Patent Application No: EP1234151 (Promessa AB—2000)—describes a process for treating organic matter, including vegetable and animal waste, which employs cryogenically cooling and freeze-drying steps, and an additional intermediate step in which the chilled matter is subjected to a splitting process in which the chilled matter is perforated with high pressure water, steam or oil, or a high energy laser.

International (PCT) Patent Application No: WO2007/053078 (Wiigh-Masak et al—2006)—this application addresses the problems associated with mouldering of remains following burial, and provides coffins having a specific C:N:P ratio suitable for promoting mouldering of the remains following burial. The process for treating the remains described in this application includes cryogenically cooling, size reduction and freeze-drying.

International (PCT) Patent Application No: WO2008/147292 (Ecof-Fin GmbH—2008)—this process describes a method in which remains are put in a coffin that includes a mineral based filler and a polyolefin binder, cryogenically cooling the body and coffin, disintegration of the chilled matter using mechanical or ultrasound means, and freeze-drying the disintegrated matter. The problem that the invention addresses is the low pH of human remains that result from conventional alternative processes such as promession, which causes acidification of the soil; this process overcomes this problem. International (PCT) Patent Application No: WO2008/116820 (DEmaco Holland BV—2008)—this process describes a method for treatment of human or animal remains including the steps of cryogenically cooling the body, size reduction of the chilled matter using mechanical or ultrasound means, and freeze-drying the size-reduced matter. The problem that the invention addresses is the inefficiency associated with freeze-drying human remains (time required, energy input), and the suggested solution is to dehydrate the remains (either prior to cooling or after size reduction) at a temperature higher than body temperature (generally less than 100° C.).

All of the above-referenced processes employ liquid cryogenic freezing as a means of freezing remains. This involves the use of pressurised cryogenic fluids, generally pressurised liquid nitrogen. While the use of such liquid cryogens is suggested for freezing human remains for further preparation, especially size reduction, the amount of liquid nitrogen that is required is very high and, as a result, quite expensive. Further, it is unrealistic to recover the liquid nitrogen after it has been used. A further problem associated with use of cryogenic liquids, especially large volumes of cryogenic liquids, is that specialised equipment is required for their storage and use. This adds further expense. Moreover, the use of liquid cryogenic liquids is hazardous, due to the safety implications for operators and the public when storing large volumes of liquid cryogen. The hazards include asphyxiation, burns, hypothermia, explosion and fire.

All of the above-referenced processes employ energy intensive means of size reducing the remains to a particulate material, including mechanical fragmentation using a hammer mill, splitting with high pressure liquid jets, and use of ultrasonic sound waves and mechanical shock. These processes lack dignity and in many cases the enabling technologies have not been shown as capable of performing to the required specification.

It is an object of the invention to overcome at least one of the above-referenced problems.

### STATEMENTS OF INVENTION

According to a first aspect of the invention, there is provided a method of treating human remains prior to burial or other means of final disposition comprising the steps of:
freezing the remains to cryogenic temperatures; and
size reducing the remains to particulate matter,
   wherein the freezing step includes the steps of:
placing the remains in a freezing chamber;
optionally charging the chamber with a gas; and
circulating gas in a closed-loop cycle between the freezing chamber and a cooling device, wherein the cooling device is adapted to cool the gas to a temperature below −100° C. while maintaining the fluid in a gaseous form.

The method of the invention employs a gas at cryogenic temperatures as a means of freezing human remains. This process involves circulating the gas through a cooling system so that it is maintained at or below −100° C. when it flows across the remains. This ensures rapid and dignified cooling of the remains, without the problems associated with use of cryogenic liquids, and also allows for the re-use of the gas employed via a scavenging system in some embodiments of the invention.

Typically, the gas cooling device includes a heatsink and a means for cooling the heatsink, wherein the circulating gas is cooled by being brought into contact with the heatsink. This enables the most efficient use of the cooling system, allowing the chilling unit to operate at its most efficient level, 24 hours per day whilst the cooling cycle for the various remains to be cooled may only specifically cool the remains for 8 hours per day. By removing liquefied gases from the primary cooling cycle the cost and associated hazards of handling, storage and transport of liquefied gases is reduced or removed.

The term “heatsink” should be understood to mean a body of material that is capable of being chilled to cryogenic temperatures and which in use takes the heat out of the circulating gas. Suitable heatsink materials may be solids or liquids, and may include ice, frozen ammonia, nitrogen, frozen brine, and iron. Preferably, the heatsink is a body of water ice.

Typically, the heatsink comprises at least one conduit for the passage of the gas through the heatsink material. Thus, when the heatsink is a body of ice or frozen ammonia, the body may be formed with conduits for passage of the gas.

Suitably, the means for cooling the heatsink comprises cooled cryogenic fluid supplied by a cryocooler, typically a mechanical cryocooler. Examples of such cryocoolers are made by the SHI Cryogenics Group of Tokyo Japan.

Preferably, heat generated by the cryogenic cooling device is re-cycled. Thus, for example, when the process of the invention employs a dehydration step to remove water from the frozen particulate, heat scavenged from the cryogenic cooling device may be employed in the dehydration step.

Generally, the heatsink is adapted to cool the gas to at or below −150° C. Ideally, the heatsink is adapted to cool the gas to below −180° C.

The gas may be a single gas, or a mixture of gasses, and should have the capacity to be cooled to a temperature of −100° C., preferably −150 C, or lower at atmospheric pressure without a phase change to liquid. Preferably, the gas is a single gas, ideally an inert gas, although non-inert gas may also be employed. Preferably, the gas is selected from helium and nitrogen. Other possible gases include hydrogen, helium, nitrogen, argon. Air may also be employed as the gas.

Generally, the step of charging the freezing chamber with the gas removes all air from the freezing chamber.

Typically, the step of circulating the gas is continued for a period of time sufficient to reduce the core temperature of the remains to below −20° C.

The invention also relates to a process for treating human remains comprising chilling the remains according to a method of the invention, and drying the remains to reduce the water content of the remains. The drying step may take place prior to, or after, the chilling step. The purpose of drying is to reduce the water content of the remains prior to pyrolysis to enable the process to provide suitable output for final disposition.

The invention also relates to a process for treating human remains comprising chilling the remains according to a method of the invention, and size reducing the chilled remains to provide fragmented remains.

The invention also relates to a process for treating human remains comprising chilling the remains according to a method of the invention, size reducing the remains to provide fragmented remains, and drying the fragmented remains to reduce the water content of the fragmented remains. The drying step may take place prior to, or after, the chilling step.

The invention also provides an apparatus for treating human remains prior to burial or other means of disposal, the apparatus comprising:
a freezing chamber adapted to receive human remains;
means for charging the freezing chamber with a gas;
a gas cooling device; and
a gas circulation means adapted to circulate the gas in a loop between the freezing chamber and the cooling device, wherein the cooling device is adapted to cool the gas to a temperature below −150° C. while maintaining the gas in a gaseous form.

Typically, the gas cooling device includes a heatsink and a means for cooling the heatsink, wherein the circulating gas is cooled by being brought into contact with the heatsink.

Preferably, the heatsink is a body of ice. Alternative materials such as ammonia, iron, frozen brine or nitrogen may be employed as the heatsink.

Typically, the heatsink comprises at least one conduit for the passage of the gas through the heatsink material. Thus, when the heatsink is a body of ice or frozen ammonia, the body may be formed with passageways for passage of the gas.

Suitably, the means for cooling the heatsink comprises cooled cryogenic fluid supplied by a cryocooler, typically a mechanical cryocooler. Examples of such cryocoolers are made by the SHI Cryogenics Group of Tokyo Japan.

In one embodiment, the apparatus further comprises:
a size reducing device adapted to receive chilled remains from the freezing chamber and size reduce the remains to a particulate material; and
a heating chamber adapted to receive the particulate material from the size reduction device, and evaporate an aqueous fraction from the particulate material,
   wherein heat generated by the gas cooling device is recycled to the heating chamber.

The invention also provides an apparatus for treating human remains prior to burial or other means of disposal, the apparatus comprising:
a cooling chamber adapted to receive human remains;
means for charging the cooling chamber with a gas;
a gas cooling device;
a gas circulation means adapted to circulate the gas in a loop between the cooling chamber and the gas cooling device, wherein the gas cooling device is adapted to cool the inert gas to a temperature below −150° C. while maintaining the fluid in a gaseous form;
a size reducing device adapted to receive suitably chilled remains from the cooling chamber and size reduce them to a particulate material; and
a heating chamber adapted to receive the particulate material from the size reduction device, and evaporate an aqueous fraction from particulate material,
   wherein heat generated by the gas cooling device is optionally employed to heat the heating chamber.

In this specification, the term “domestic animal” should be understood to means domestic pets, for example, dogs, cats, and rodents.

In this specification, the term “biological material” should be understood to mean waste material that contains biological subject matter such as blood, serum, cells, tissue, organs or limbs. Examples of such material include clinical and medical waste material, waste from hospitals, and other types of biohazardous waste.

In another aspect, the invention provides a process of treating human remains prior to burial or other means of commitment and comprising a step of fragmentation of the remains by exposing the remains to a shockwave generated by a detonation, wherein the fragmentation step is carried out in a size reduction chamber having a platform for receiving the remains, means for causing a detonation to generate the shockwave and consequent fragmentation of the remains, and a waveguide adapted to direct the shockwave towards the platform.

The process of the invention provides a dignified and efficient means of reducing human remains to a particulate material, whereby a shockwave generated by a detonation is focussed onto human remains according to the design of the size reduction chamber. In one embodiment, the shape of the chamber itself provides the guide means for focusing the pressure wave onto the subject. Alternatively, various types of waveguides may be provided in the chamber for focusing and transmitting the pressure wave.

In a preferred embodiment, the process comprises an initial step of freezing the remains prior to fragmentation. Various means are provided for freezing remains, for example exposing the remains to a liquid or gas at cryogenic temperature.

In a preferred embodiment, the process comprises a further step of removing water from the remains prior to or after fragmentation, and ideally after fragmentation. Thus, water is removed preferably from the fragmented remains, preferably by evaporative drying. Generally, the remains are dehydrated until 1-20%, and preferably about 8% water (w/w) is left in the remains.

Typically, the means for generating the detonation is disposed towards the top of the size reduction chamber, and wherein the waveguide means is provided by a top of the chamber that is shaped to focus the pressure wave towards the platform. This avoids the requirement to provide separate waveguides in the chamber.

Suitably, the waveguide means comprises a barrel that is disposed within the chamber such that the shockwave generated by the detonation is guided by the barrel towards the platform. In one embodiment, the means for generating the detonation is disposed within the barrel.

Preferably, the waveguide means comprises a plurality of barrels, for example at least 2, 3, 4, 5, 6, 7, 8, 9, 10 or 11. Ideally, between 2 and 20, or 3 and 10, barrels are provided, wherein each barrel is disposed within the chamber to direct the shockwave at the platform. This provides a simple and effective means of directing shockwaves at human remains which ensures effective size reduction of the frozen remains. In cases where a plurality of barrels are provided, each barrel may communicate with a single detonation chamber, whereby the shockwave generated by the detonation is guided from the detonation chamber towards the platform by means of the barrels.

Typically, the means for generating the detonation and shockwave comprises an oxygen gas supply nozzle and a hydrogen gas supply nozzle disposed within the chamber to provide a mixture of oxygen and hydrogen within the chamber at a location spaced apart from the platform, and means for initiating the mixture of oxygen and hydrogen gas.

It will be appreciated that other gas mixtures may be employed such as oxygen and acetylene, or oxygen and formaldehyde or other gases which detonate in the correct ratio and mixture with air, or oxygen. These could be used in place of hydrogen gas.

Suitably, the process includes a step of generating a series of detonations, for example from 2 to 20, separated by between 0.01 and 5 seconds, preferably separated by less than 2 seconds, and ideally less than 1 second.

In a second aspect, the invention provides an apparatus suitable for fragmentation of human remains, typically intact remains, and comprising a size reduction chamber having a platform for receiving and supporting the remains, a means for generating a detonation and consequent shockwave disposed in a spaced-apart relationship to the platform, and a waveguide means adapted to direct the shockwave generated by the explosion towards the platform.

Preferably, the apparatus includes a cooling chamber adapted to subject the remains to cryogenic temperatures, and optionally a means for transferring the remains from the cooling chamber to the size reduction chamber.

Typically, the apparatus includes a drying chamber adapted to receive the remains and capable of removing water from the remains. Typically, the apparatus includes a drying chamber adapted to receive the fragmented remains and capable of removing water from the particulate material. Suitably, the apparatus includes means for transferring the fragmented remains from the size reduction chamber to the drying chamber. The drying chamber removes water from the fragmented remains, by any suitable means including evaporative drying or lyophilisation.

Thus, in a preferred embodiment, the invention provides an apparatus for treating human remains comprising a cooling chamber for subjecting the remains to cryogenic temperatures, a size reduction chamber adapted to receive the cooled remains and including a shockwave generation apparatus adapted to generate a shockwave capable of fragmentation of the frozen remains, and a drying chamber adapted to receive the fragmented remains and capable of removing water from the fragmented remains, wherein the size reduction chamber comprises a platform for receiving and supporting the frozen remains, means for generating a detonation and consequent pressure wave disposed in a spaced-apart relationship to the platform, and a waveguide means adapted to direct the pressure wave generated by the detonation towards the platform.

Suitably, the means for generating the detonation is disposed towards a top of the size reduction chamber, and wherein the waveguide means is provided by a top of the chamber that is shaped to focus the shockwave towards the platform.

Suitably, the waveguide means comprises a barrel that is disposed within the chamber such that the shockwave generated by the detonation is guided by the barrel towards the platform. In one embodiment, the means for generating the detonation is disposed with the barrel. The barrel may be any geometrical shape or cross section, and is not limited to cylindrical shape and not limited to any particular cross sectional shape.

Preferably, the waveguide means comprises a plurality of barrels, for example at least 2, 3, 4, 5, 6, 7, 8, 9, 10 or 11. Ideally, between 2 and 20, or 3 and 10, barrels are provided, wherein each barrel is disposed within the chamber to direct the pressure wave at the platform. This provides a simple and effective means of directing pressure waves at human remains which ensures effective size reduction of the frozen remains. In cases where a plurality of barrels are provided, each barrel may communicate with a single detonation chamber, whereby the shockwave generated by the detonation is guided from the detonation chamber towards the platform by means of the barrels.

Suitably, the means for generating the detonation comprises an oxygen gas supply nozzle and a hydrogen gas supply nozzle disposed within the chamber to provide a mixture of oxygen and hydrogen within the chamber at a location spaced apart from the platform, and means for igniting the mixture of oxygen and hydrogen.

Preferably, the apparatus includes a means for generating a series of detonations separated by between 0.01 and 5 seconds, preferably separated by less than 2 seconds, and ideally less than 1 second.

In a third aspect, the invention provides a computer program comprising program instructions for causing a computer to perform the method of the invention. The computer program is typically embodied on a record medium, a carrier signal, or on a read-only memory.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

In this specification, the term “human remains” should be understood to mean a deceased human body, typically intact.

In this specification, the term “cryogenic treatment” or “cryogenically freezing” refers to bringing the remains into contact with a cryogenic fluid, such as but not limited to nitrogen or helium, having a temperature of not greater than −100° C. The term “cryogenic fluid” should be understood to mean a fluid that exists in a gaseous or liquid form at −100° C.

The term “evaporative drying” refers to a process in which water is removed from the remains due to the application of heat. The temperature of evaporation is greater than body temperature, and generally is greater than 100° C., preferably from 100° C. to 250° C., more preferably from 200° C. to 250° C. In an alternative embodiment, the water may be evaporated by flash evaporation. Flash evaporation is a technique which is well known to a person skilled in the art, and will not be described in more detail herein. The temperature of evaporation is greater than body temperature, and generally is greater than 150° C., preferably from 200° C. to 250° C. The time required for evaporation depends on a number of factors, including the weight and water content of the remains, the evaporation temperature, and the amount of water that is to be removed. In general, the evaporation step will be carried out at atmospheric pressure, however in some embodiments the evaporation may be carried out at a different pressure. Generally, the evaporation step reduces the water content of the frozen particulate material to leave approximately 1 to 10% water (w/w) in the remaining solids.

In this specification, the term “core temperature” should be understood to mean the temperature at the core of the remains. In humans, this would be, for example, the temperature in the centre of the human torso, generally the warmest part of the remains during the chilling cycle.

In this specification, the term “size reduction” should be understood to mean the process in which a mass is fragmented into a particulate. The term “particulate” should be understood to mean composed of particles that are produced as a result of size reduction. The particulate may be of any size, but generally has an average particle size of 10 mm or less (i.e. at least 50% of the particles have a diameter when measured at their widest of 10 mm or less). Ideally, the particulate has an average particle size of less than 10 mm.

In this specification, the term “flash evaporation” should be understood to mean an evaporation process when a saturated liquid stream undergoes a reduction in pressure by passing through a throttling valve or other throttling device.

The term “animal remains” should be understood to mean agricultural animals such as cows, sheep, goats and poultry, and larger animals such as elephants and giraffes, where the remains are typically substantially intact.

### BRIEF DESCRIPTION OF THE FIGURES

The invention will be more clearly understood from the following description of some embodiments thereof given by way of example only, with reference to the following figures, in which:

FIG. 1 is a flow chart illustrating a process of the invention in which human remains are frozen with a circulating cryogas;

FIG. 2 is a flow chart illustrating a process according to an alternative embodiment of the invention in which the cryogas is helium;

FIG. 3 is a flow chart illustrating a continuous cooling process according to an alternative embodiment of the invention; and

FIG. 4 is a flow diagram illustrating a process according to another aspect of the invention;

FIG. 5 is an illustration of an apparatus according to the invention;

FIG. 6 is a sectional elevational view of a size reducing chamber forming part of the apparatus of the invention;

FIG. 7 is a sectional elevational view of an alternative size reducing chamber forming part of the apparatus of the invention; and

FIG. 8 is a detailed view of a barrel forming part of the size reducing chamber of Fig.

### DETAILED DESCRIPTION OF THE INVENTION

### Chilling:

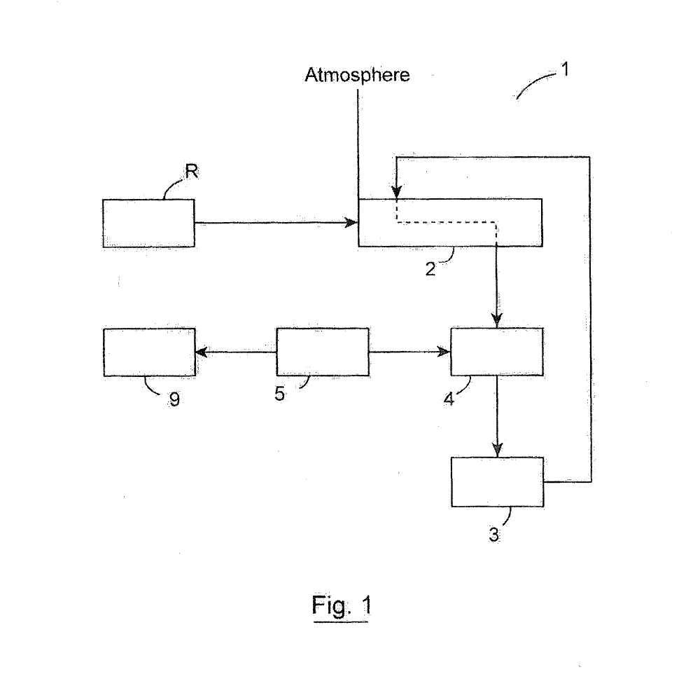

Referring to the drawings, and initially to FIG. 1 a flow chart is provided illustrating the process of the invention, indicated generally by the reference numeral 1. The process involves an initial charging step where the chilling chamber 2 is loaded through an insulated door with an encapsulated set of human remains R. The chamber is then purged of air by the introduction of the chilling gas. The gas is then circulated across the encapsulated remains in the chilling chamber 2, cycling through insulated pipework to a heatsink 4 made of primarily water ice whereupon the gas circulates through the heatsink 4 and returns via a pump 3 and more insulated pipework to the chilling chamber 2 to cool the remains further. The heatsink 4 is cooled by a commercial mechanical cryocooler 5, operably connected to an evaporator, the temperature being maintained at a level where by the circulating gas can cool the remains to the required level.

In the charging stage the door is opened to admit the encapsulated human remains, which are emplaced within the chamber. Optionally the encapsulation may contain apertures to facilitate the introduction of the chilling gas to enable cooling of the remains to take place more rapidly. The chamber is then sealed against the ingress of air and the cooling process can begin.

The cooling gas is then introduced to the cooling chamber from the bottom. Optionally the gas may be introduced from the top, depending on the type of gas used and its temperature at the time of its introduction into the chamber. In this manner air is displaced and is removed from the chamber by insulated pipework, following which the egress route is sealed against the atmosphere.

It will be appreciated that the remains do not necessarily have to be encapsulated; they may be placed without further covering in the cooling chamber.

The cooling step is conducted by allowing the gas to flow over the encapsulated remains, and optionally through the capsulation, to cool the remains down to the required temperature. The remains are preferably cooled to a core temperature of at least −20° C. This cooling is achieved by re-cooling the gas continually by circulating it through a heatsink made of predominantly water ice and maintained at a temperature of generally −150° C. by a cryocooler sourced and specified for the purpose.

The cryocooler maintains the temperature of the heatsink at a working temperature whereby the remains may be chilled to required temperature, generally below −20° C. by the gas which has been chilled. The heatsink is continually cooled 24 hours per day, therefore it will be appreciated that in this embodiment of the invention the heatsink temperature will fluctuate, rising during the cooling process and cooling down when the system is quiescent.

When the remains have been chilled sufficiently, known to those expert in the art by the length of time for which they have been actively cooled, generally about 55 minutes, the gas circulation stops and the chamber door may be opened to allow subsequent operations to take place, namely size reduction operations, for which the remains are now suitable, having been chilled to a point of great embrittlement.

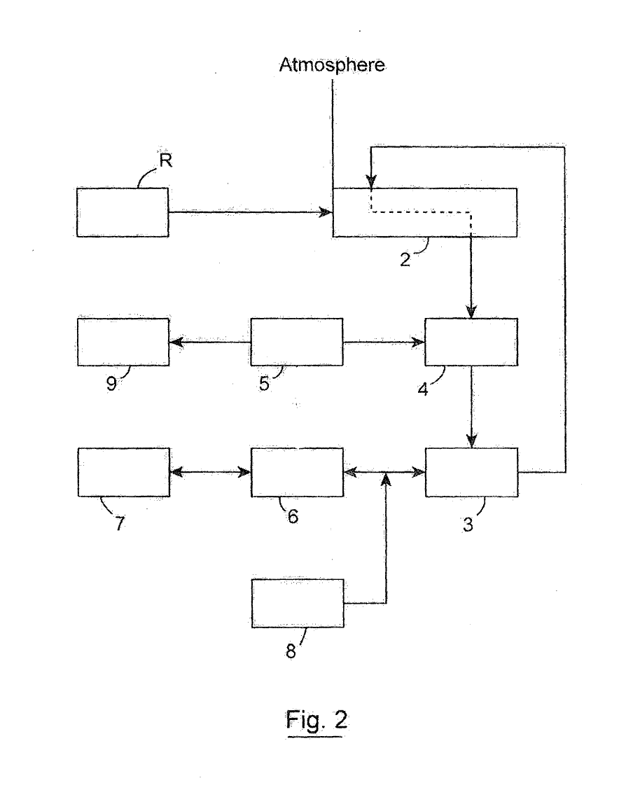

In one embodiment of the invention shown in FIG. 2 the cooling gas to be recirculated is helium gas. In this embodiment the gas is recycled by employing a vacuum pump 3 and a pressure intensifier 6 to scavenge the gas and to store it in a pressurised vessel 7 for re-use during subsequent cooling cycles. In this embodiment it may be necessary to replenish the cooling gas in the cycle from time to time and this is achieved by the use of a replenisher system 8.

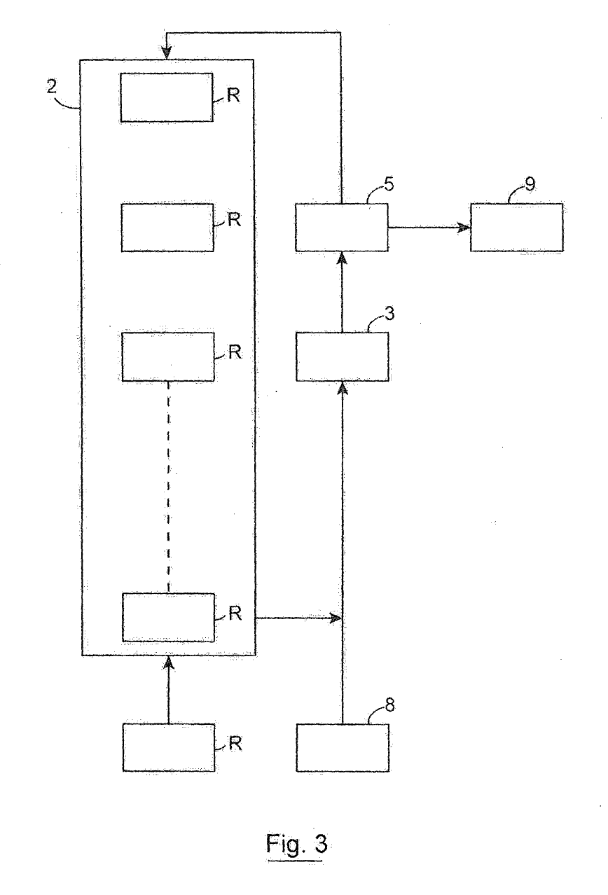

In another embodiment shown in FIG. 3, the method of the invention comprises a continuous cooling system where a plurality of remains R will be located within the cooling chamber at any-one time, with remains continually be being loaded into and removed from the cooling chamber. As cooling of the remains takes place on a continuous basis, no heatsink is required in this embodiment, the cooling gas circulating between the cooling chamber and the cryocooler. In addition, this, allows the remains to be chilled over a longer period of time which may facilitate storage of the remains for a longer period if this is required, or an ability to handle a larger set of human remains than average within a viable timeframe.

In another embodiment of the invention, human remains are chilled according to one of the methods described above with reference to FIGS. 1 to 3. The chilled remains are then subjected to size reduction by exposing the chilled remains to a pressure wave, which results in the remains shattering into small fragments. The fragments are then placed in a drying chamber and subject to evaporative drying for a period of time sufficient to reduce the water content of the fragments to about 8% (w/w). The partially dried fragments are then subjected to pyrolysis at a temperature of 900° C. for up to two hours to reduce the fragmented remains to biochar. The biochar is then oxidised, prior to being placed into an urn for burial.

### Fragmentation:

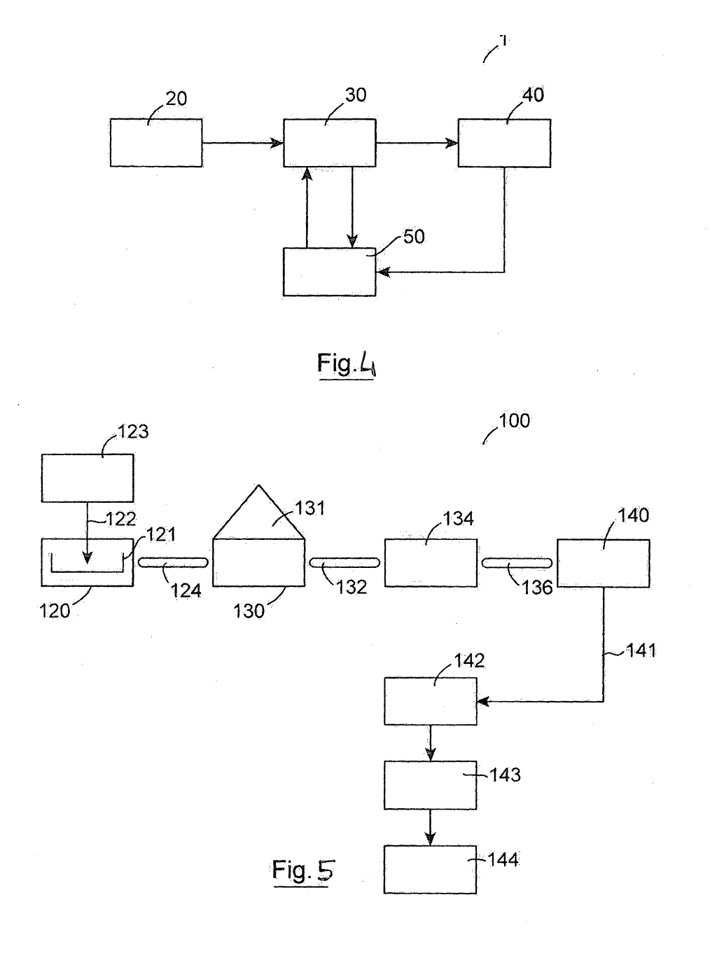

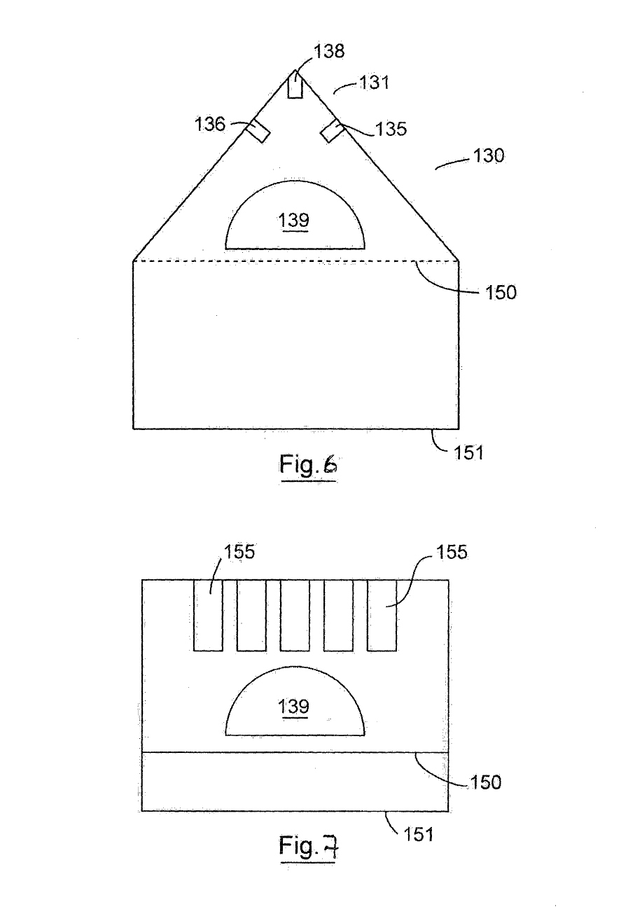

Referring to the drawings, and initially to FIG. 4, a flow chart is provided illustrating the process of another aspect of the invention, indicated generally by the reference numeral 10. The process involves an initial freezing stage 20, where the remains are subject to a cooling process, a subsequent size reduction stage 30, where the frozen remains are subjected to a pressure wave to size reduce them to a particulate material, and an evaporation stage 40 where the particulate material is heat treated to evaporate water from the particulate matter to provide a partially de-watered particulate material for subsequent steps. Each of the individual steps will now be described in more detail.

In the freezing stage 20, the remains are placed in a freezing bath in a freezing vessel, and liquid nitrogen at a temperature of −196° C. is poured into the bath until the remains are completely immersed in liquid nitrogen. The remains are left immersed in the liquid nitrogen for a period of 1 hour, which is sufficient to reduce the core temperature of the remains to −100° C. or less. The frozen remains are then removed from the bath and freezing vessel for further processing. It will be appreciated that other methods of freezing the remains will be available, for example immersing them in liquid helium or liquid hydrogen or another cryogenic liquids or gases.

In the size reduction stage 30, the frozen remains are subjected to a size reduction process where they are converted to a particulate matter by means of a pressure wave generated through initiation of an oxygen and hydrogen gas mixture. The frozen particulate matter is then optionally screened to ensure that the particulate matter has the desired average particle size. The screening also removes large metal objects from the particulate, for example metal prostheses such as replacement hips or joints. The particulate matter may also be subjected to a magnetic screening process to remove small ferrous metal objects from the coarse particulate, prior to further processing.

In the de-watering stage 40, the particulate matter generated during the size-reduction stage is subjected to an evaporative heat treatment to remove water. The particulate matter is placed in a heater chamber, and heated at a temperature of up to 250° C. for a period of 30 minutes whereupon most of the water (about 95%) in the particulate is removed by evaporation at atmospheric pressure. Water removed from the particulate is then condensed and optionally stored.

Referring to FIG. 5, there is illustrated an apparatus for treating human remains according to the invention, and indicated generally by the reference numeral 100. The apparatus 100 comprises a cooling vessel 120 having a freezing bath 121 into which the remains (not shown) are placed. A cryogenic fluid line 122 is provided for conveying liquid nitrogen from a liquid nitrogen storage vessel 123 to the freezing bath. Conveyor means 124 are provided to convey the frozen remains from the freezing chamber 120 to a size reduction chamber 130, where the frozen remains are size reduced by means of a pressure wave generation apparatus 131 to a particulate material (described in more detail below). A screen 132 segregates the particulate to retain any particulate matter having a particle size greater than 10 mm. The coarse fraction is then continuously reduced in the size reduction chamber 130. The particulate matter is then subjected to a magnetic separation step 134 where any ferrous metal objects are removed from the particulate.

A conveyor 136 conveys the particulate matter to a heating chamber 140, where the particulate is heated to evaporate water from the particulate. The heating chamber 140 includes a water vapour removal line 141 from which water vapour in the chamber is removed and conveyed to a condenser 142, where the vapour is condensed into a distillation unit 143 where the water is distilled to separate water from other aqueous fractions, for example formalin, and the distilled water is then stored in a water storage vessel 144.

In more detail, and referred to in FIG. 6, the size reduction chamber 130 is described in which parts having the same reference numerals as those described with reference to previous embodiments are assigned the same reference numerals. The chamber 130 is adapted for receipt of human remains, and includes the pressure wave generation apparatus 131 which comprises a first and second nozzles 135, 136 for injecting oxygen and hydrogen into a top of the chamber, and an initiation device 138 disposed towards the top of the chamber for igniting the gasses to initiate the gas mixture and generate the shock wave. The chamber has a generally triangular cross-sectional shape which acts to deflect the pressure wave from the detonation down and towards the remains 139 which are positioned on a platform 150. The platform 150, upon which the remains rest, may be formed of perforated material to enable the particulate material generated as a result of the pressure wave to pass through and be collected on a sub-platform 151. In use, oxygen and hydrogen gas in the amount of about 5 litres at atmospheric pressure are injected into the top of the chamber where they mix, and are then initiated causing the mixture of oxygen and hydrogen to detonate. The shock wave generated as a result of the detonation is then deflected by the shape of the chamber downwards and towards the remains, which are disposed towards the base of the chamber.

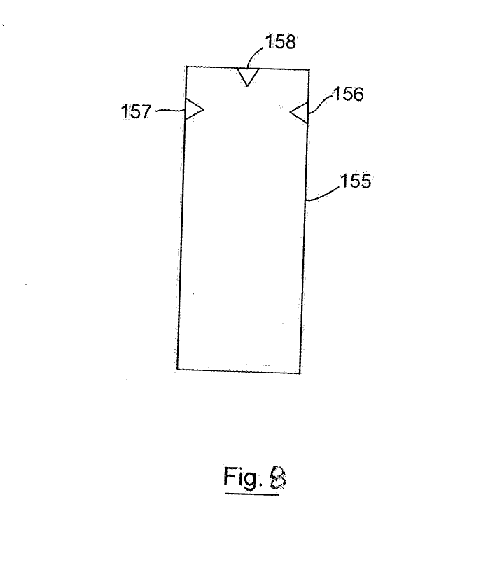

Referring to FIG. 7, there is illustrated a size reduction chamber according to an alternative embodiment of the invention in which parts identified with reference to the previous embodiments are assigned the same reference numerals. In this embodiment, the detonation generation means comprises a plurality of barrels 155 disposed towards a top of the chamber, and pointing towards the platform 150. Referring to FIG. 8, each barrel 155 includes initiation means disposed towards a top of the barrel, namely an oxygen supply nozzle 156, a hydrogen supply nozzle 157, and an ignition 158 adapted to ignite the mixture of oxygen and hydrogen generated in the barrel 155. In use, frozen human remains are plated on the platform 150, and oxygen and hydrogen gasses are supplied to each barrel 155 generating a hydrogen/oxygen mixture in the top of the barrel which is initiated causing a detonation and consequent shock wave which is guided by the barrel towards the human remains, causing the human remains to shatter into a particulate.

The invention is not limited to the embodiment hereinbefore described, which may be varied in construction and detail without departing from the spirit of the invention.

1-55. (canceled)

56. A method of treating human remains prior to burial or other means of disposal comprising the steps of:
freezing the remains; and
size reducing the remains to particulate matter,
wherein the freezing step includes the steps of:
placing the remains in a freezing chamber;
charging the chamber with a gas; and
circulating the gas in a loop between the freezing chamber and a cooling device, wherein the gas cooling device is adapted to cool the gas to a temperature below −100° C. while maintaining the gas in a gaseous form.

57. A method as claimed in claim 56 in which the gas cooling device includes a heatsink and a means for cooling the heatsink, wherein the circulating cryogas is cooled by being brought into contact with the heatsink.

58. A method as claimed in claim 57 in which the heatsink is a body of ice.

59. A method as claimed in claim 58 in which the body of the heatsink comprises at least one conduit for the passage of the gas therethrough.

60. A method as claimed in claim 57 in which the means for cooling the heatsink comprises cooled cryogenic fluid supplied by a cryocooler.

61. A method as claimed in claim 56 in which heat generated by the cryogenic cooling device is re-cycled.

62. A method as claimed in claim 57 in which the heatsink is adapted to cool the gas to below −150° C., optionally below −180° C., optionally below −200° C.

63. A method as claimed in claim 56 in which the gas is capable of remaining in gaseous form at a temperature of −100° C. or lower, −150° C. or lower, or −200° C. or lower, at atmospheric pressure.

64. A method as claimed in claim 56 in which the step of charging the freezing chamber with gas removes all air from the freezing chamber.

65. A method as claimed in claim 56 in which the step of circulating the gas is continued for a period of time sufficient to reduce the core temperature of the remains to below −20° C.

66. A method as claimed in claim 56 in which the gas cooling device is a cryocooler.

67. An apparatus for treating human remains prior to burial or other means of final disposition, the apparatus comprising:
a cooling chamber adapted to receive human remains;
optionally, means for charging the cooling chamber with a gas;
a gas cooling device; and
gas circulation means adapted to circulate gas in a loop between the cooling chamber and the gas cooling device, wherein the gas cooling device is adapted to cool the gas to a temperature below −100° C. while maintaining the gas in a gaseous form.

68. An apparatus as claimed in claim 67 in which the gas cooling device includes a heatsink and a means for cooling the heatsink, wherein the circulating gas is cooled by being brought into contact with the heatsink.

69. An apparatus as claimed in claim 68 in which the heatsink comprises a body of material capable of being frozen to a temperature of −100° C. or lower.

70. An apparatus as claimed in claim 69 in which the heatsink is a body of ice.

71. An apparatus as claimed in claim 69 in which the body of material comprises at least one conduit for the passage of the gas therethrough.

72. An apparatus as claimed in claim 68 in which the means for cooling the heatsink comprises cooled cryogenic fluid supplied by a cryocooler.

73. An apparatus as claimed in claim 67 and further comprising:
a size reducing device adapted to receive chilled remains from the freezing chamber and size reduce the remains to a particulate material; and
a heating chamber adapted to receive the particulate material from the size reduction device, and evaporatively dry the particulate material,
wherein heat generated by the gas cooling device is recycled to the other parts of the process cycle.

74. An apparatus as claimed in claim 73 in which the heat generated by the cryocooler is recycled to the heating chamber.

75. An apparatus as claimed in claim 67 in which the gas is capable of remaining in gaseous form at a temperature of −100° C. or lower, −150° C. or lower, −200° C. or lower at atmospheric pressure.
